(19) United States
(12) Patent Application Publication
(10) Pub. No.: US 2025/0205744 A1
(43) Pub. Date: Jun. 26, 2025

(54) PLASTIC SORTING BY POST-CONSUMER TAGGING

(71) Applicant: Katholieke Universiteit Leuven, Leuven (BE)

(72) Inventors: Rob AMELOOT, Leuven (BE); Victor RUBIO GIMENEZ, Valencia (ES)

(21) Appl. No.: 18/848,274

(22) PCT Filed: Mar. 27, 2023
(86) PCT No.: PCT/EP2023/057837

§ 371 Date: Sep. 18, 2024

(30) Foreign Application Priority Data
Mar. 25, 2022 (EP) 22164373.7

(51) Int. Cl. B07C 5/342; B29B 17/02

(52) U.S. Cl. CPC B07C 5/342; B29B 17/02; B07C 2501/0054; B29B 2017/0279; B29B 2017/0282

(57) ABSTRACT

Methods of enriching plastic items from a composition comprising one, or different types of plastic comprising the steps of: labelling the one or different types of plastics in said composition with one or more molecules that are fluorescent and/or absorb light in the ultraviolet, visible or near-infrared range, enriching one or more types of plastic from said composition based on the resulting fluoresce and/or absorbance properties of the labelled plastics.

### FIELD OF THE INVENTION

The invention relates to methods of sorting different types of plastics, especially different types of black plastic in plastic waste.

The invention further relates to specific labelling of plastics with compounds that absorb or emit light in a relevant wavelength rage.

### BACKGROUND OF THE INVENTION

To enable recycling, it is important to separate different plastic types from one another. Sorting based on near-infrared (NIR) spectroscopy is the industry standard. However, there are several cases where NIR sorting fails, often resulting in incinerating or landfilling the unsorted fraction. For instance, black and dark-coloured plastics form a serious problem for the recycling industry since the standard carbon black pigment absorbs nearly all NIR irradiation. As a result, insufficient radiation is reflected back to the detector to enable classification of the polymer. Unfortunately, alternative optical sorting methods do not offer a robust and economical solution and non-spectroscopic methods (e.g., sink-float or electrostatic separation) cannot reach the desired selectivity.

Because of the magnitude of this problem, dedicated alternative methods are being explored that require changes to the polymer production process. For instance, alternative black pigments and dyes that are transparent in the NIR region have been developed. However, it is unlikely that these will replace carbon black because of their cost. Moreover, carbon black also acts as a stabilizer and reinforcing filler and has excellent dispersion and masking properties. Luminescent tracers have been developed that emit light under UV irradiation to overcome the issue of NIR absorption. However, these tracers are not very efficient as they are dispersed uniformly throughout the resin and therefore require relatively high concentrations. These tracers can be used as ‘digital watermarks’ included either during label printing or moulding. However, this approach would require unprecedented collaboration, process changes, and hardware updates of all packaging manufacturers, sorting plants, and recycling facilities. Even in the best-case scenario, this technology would be limited mainly to packaging and would not be able to deal with legacy plastics or other sources of post-consumer plastics such as automotive shredder residue.

### SUMMARY OF THE INVENTION

The invention is summarised in the following statements.

1. A method of enriching plastic items from a composition comprising one, or different types of plastic comprising the steps of:
labelling the one or different types of plastics in said composition with one or more molecules that are fluorescent and/or absorb light in the ultraviolet, visible or near-infrared range,
enriching one or more types of plastic from said composition based on the resulting fluoresce and/or absorbance properties of the labelled plastics.

2. The method according to statement 1, which comprises the step of identifying a type of plastic by fluorescence and/or absorption of ultraviolet, visible or near-infrared light

3. The method according to statement 1 or 2, which comprises the step of identifying a type of plastic by fluorescence and/or absorption of visible light.

4. The method according to any one of statements 1 to 3, wherein a step of identifying and enriching plastic items by near-infrared is performed prior to the step of identifying and enrichment of plastic items based on the fluoresce or absorbance of said fluorescent and/or visible light absorbing molecules.

5. The method according to any one of statements 1 to 4, wherein the one or of different types of plastics in said composition comprises at least 50, 60, 70, 80 or 90% (w/w) of black or dark plastic.

6. The method according to any one of statements 1 to 5, wherein said molecule is a fluorescent molecule.

7. The method according to any one of statements 1 to 6, where the enrichment is performed using a fluorescent and/or visible light absorbing molecule that preferentially binds or diffuses into a specific type of plastic.

8. The method according to any one of statements 1 to 7, where the enrichment is performed using a fluorescent and/or visible light absorbing molecule that is preferentially absorbed within a specific type of plastic.

9. The method according to any one of statements 1 to 8, wherein the enrichment is performed using a fluorescent and/or visible light absorbing molecule that, depending on the type of plastic it binds to, has a different emission spectrum upon ultraviolet irradiation or a different absorption spectrum in the visible or near-infrared range.

10. The method according to any one of statements 1 to 9, wherein the fluorescent and/or visible light absorbing molecule is water-soluble or is soluble in a water/alcohol mixture

11. The method according to any one of statements 1 to 10, wherein the labelling with fluorescent and/or visible light absorbing molecule is performed by applying 1 g to 1 kg of molecule per ton plastic items.

12. The method according to any one of statements 1 to 11, wherein the labelling with the fluorescent and/or light-absorbing molecule is performed during washing of the plastic items in the composition.

13. The method according to the previous statement wherein the washing solution comprises between 1-10000 mg fluorescent and/or visible light absorbing molecule per litre solution.

14. The method according to any one of statements 1 to 13, wherein the composition is food waste comprising plastic items.

15. The method according to any one of statements 1 to 14, wherein the plastic items are shredded plastic items.

16. The method according to any one of statements 1 to 15, wherein the binding of the fluorescent and/or visible light absorbing molecule to the plastic item is non-covalent.

17. The method according to any one of statements 1 to 16, wherein the fluorescent and/or visible light absorbing molecule is removed by washing the plastic items with a solution comprising at least 1, 10, 25, 50 or 75% of an alcohol.

18. The method according to any one of statements 1 to 17, wherein the dye is food grade.

19. The method according to any one of statements 1 to 18, wherein a fluorescent and/or light-absorbing molecule is used which preferentially binds to or diffuses into the plastic type which is least abundant in the mixture.

### DETAILED DESCRIPTION

The invention relates to methods of plastic sorting via labelling and separating post-consumer plastics types, especially dark coloured and black plastics.

These methods differ from the prior art wherein coloured tags are included during the manufacturing of a plastic.

The claimed separation methods do not require changes in manufacturing processes and can be carried out using standard sorting equipment.

The methods of the present invention result in increased volumes and quality of sorted polymers and divert streams from incineration to mechanical recycling.

The methods of the invention provide a universal method for labelling and separating different post-consumer plastics types, irrespective of how the plastic was produced.

The method is based on labels that are added during a standard or additional washing step at a sorting or recycling facility. The labels have a well-selected spectral signature and allow to differentiate between different plastics based on their affinity for the polymer surface and how fast the label diffuses into the polymer.

Different sorting challenges require different labels:
For black plastics, typically a fluorescent label is used.
Labels to separate polymer grades with a near-identical chemical composition more effectively (e.g., aPET (amorphous Polyethylene terephthalate) versus cPET (crystalline Polyethylene terephthalate) or HDPE high-density polyethylene versus MDPE (medium-density polyethylene) differ in diffusivity in polymers with different crystallinity/density.
To remove polymer contaminants (e.g., PE from PET or chlorinated from non-chlorinated plastics), labels preferentially label the contaminant fraction.

Typically labels are added during the standard washing step or additional washing step (for instance, <80° C. in aqueous media), whereby residence time and bath temperature are used to steer the adsorption and diffusion into the polymer to attain optimal differentiation between different plastics. More specifically, the labelling can be performed during the standard washing step such that there is no additional water consumption.

After drying, plastic flakes are optically sorted and processed.

The methods of the present invention are suitable for the separation of amorphous PET from crystalline PET.

The methods of the present invention are suitable for the separation of High Density PE Medium Density PE and low density PE.

The methods of the present invention are suitable for the separation of PET from PE.

The methods of the present invention are suitable for the separation of chlorinated polymers such as PVDC and PVC from polyolefins.

The sorting step is carried out using standard optical sorting equipment with a spectral range suitable for the selected labels. These sorting tools have largely the same layout for different applications and can typically be easily reconfigured (e.g., by using a different optical filter and/or software updates of the sorting algorithm).

Standard optical sorting equipment is often already available for secondary sorting at recyclers.

If needed, label removal can be carried out in different ways, depending on the label properties. One option is label removal during the extrusion of new pellets by volatilization from the polymer melt. This approach requires no additional infrastructure and is used already for deodorization of recycled polymers. Another option is to remove the label during a washing step.

“Plastic items” refers to objects consisting of plastic or comprising at least 70, 80, 90, 95, or 99% plastic. Plastic items for use in the methods of the present are not limited in size or shape. Typical items include plastic foils, wraps and containers from food packaging and plastic parts from consumer electronic products. Preferred plastic items are shredded pellets obtained from plastic waste. These pellets typically have a size of between 0.25 and 1 cm and a weight of between 1 and 5 mg.

Plastic refers to compositions such as, but not limited to, PET (Polyethylene terephthalate), PE (polyethylene), PP (polypropylene), PVC (polyvinyl chloride), polyamides such as nylon, and PS (polystyrene).

When referring to a type of plastic, this means that the composition contains at least 70, 80, 90, 95 or 99% of a specific plastic.

“Enriching” a plastic from a mixture means that at least 25, 50, 60, 70, 80, 90, or 95 wt % of plastic in said mixture is removed.

“separating” a plastic from a mixture means that at least 80, 90, 95, or 98 wt % of plastic in said mixture is removed.

“isolating” a plastic from a composition comprising non-plastic items means that at least 25, 50, 60, 70, 80, 90 or 95 wt % of plastic in said mixture is removed.

“Dark” plastic refers to plastic that upon irradiation with near-infrared light absorbs at least 90% of the light.

“black” plastic refers to plastic that upon irradiation with near-infrared light absorbs at least 99% of the light.

“Label” refers to an organic molecule with at least one of the following properties:
absorbs in the visible spectrum upon illumination with visible light
emits light in the visible spectrum upon illumination with visible or ultraviolet light
absorbs light in the near-infrared spectrum upon illumination with near-infrared light.

Suitable candidate dyes which come into account for the methods of the present invention are Coumarin, Coumarin 343, Nile red, Riboflavin, Fluorescein, Curcumine, Alizarine, Lapachol, Beta-carotene, Alfa-carotene, Lycopene, Allura red, Sunset Yellow E110, Indigo carmine, Fast green, Erioglaucine disodium.

In the present invention, labels show preferential binding and/or diffusion into different types of plastic because of different interactions with the plastic. For successful sorting, it is not necessary that a label binds to or diffuses into exclusively one type of plastic. Multiple labels with different binding or optical properties can be used in parallel. The total optical response of the plastics after the labelling protocol, either in absorption or emission mode, is used to enable sorting. The classification algorithm used in the sorting step can make use of any number of emission or absorption wavelengths and in any combination.
The label concentration that binds on a plastic depends on the nature of the plastic. The binding is generally via non-covalent bonds.
The label adsorption preference depends on the plastic type. The surface adsorption preference may differ from the penetration and enrichment properties into the plastic.
The absorption or emission properties of a given label can differ upon binding to different plastics. For instance, a given label binding to different plastics may emit a different wavelength upon irradiation with the same light source.

It is understood that a label may have different properties to the above.

### EXAMPLES

### Example 1

Black plastic PET and PE flakes have been treated with the commercial dyes iDye Poly Pink and iDye Poly Blue (10 mins, 100° C., 5 g dye/100 ml water).

Treated flakes are removed from the solution.

For iDye Poly Blue, upon UV illumination PET shows no emission, while PP turns brown.

For label iDye Poly Pink, upon UV illumination PET turns bright red, while PP turns brown.

### Example 2

Virgin LDPE, HDPE and PET pellets were treated with the commercial dyes iDye Poly Pink and iDye Poly Blue. (ranging from 10 mins to 1 month, and temperatures between room temperature and 100° C., 5 g dye/100 mL water).

Upon UV illumination at 250 nm, iDye Poly Blue treated LDPE and HDPE are brown, while PET shows no colour.

Upon UV illumination at 250 nm, iDye Poly Pink treated LDDE and HDPE are orange, while PET turns intense pink-red.

LDPE and HDPE differ from each other in that LDPE has a more intense colour that HPDE. Labelling for shorter time and/or lower temperature results in a HDPE which is essentially unstained and allows an easy separation of unstained HDPE and stained LDPE.

### Example 3

Black PET, PE and PS flakes were treated with the commercial dyes iDye Poly Pink and iDye Poly Blue. (ranging from 10 mins to 1 day, and temperatures between room temperature and 100° C., 5 g dye/100 ml water)

Upon UV illumination at 250 nm, PET and PS labelled with iDye Poly Blue shows no colour, while PP at turns brown when intense labelling occurred.

Upon UV illumination at 250 nm, PET labelled with iDye Poly Pink turns red while PP and PS show no colour.

Only upon intense labelling conditions, PP turns brown and PS turns orange.

### Example 4

Virgin LDPE, Virgin HPDE, Virgin PET, black PET, black PP and black PS are treated with Nile Red (2 hours, room temperature, 1 mg dye/11 mL acetone:water 1:10).

Upon UV illumination at 250 nm virgin LDPE, and HDPE turn yellow while virgin PET turns pink.

Upon UV illumination at 250 nm, black PET turn intense red, black PP intense olive green, while black PS shown and a light and unequal orange colour

1. A method of enriching plastic items from a composition comprising one, or different types of plastic comprising the steps of:
labelling the one or different types of plastics in said composition with one or more molecules that are fluorescent and/or absorb light in the ultraviolet,
visible or near-infrared range,
enriching one or more types of plastic from said composition based on the resulting fluoresce and/or absorbance properties of the labelled plastics.

2. The method according to claim 1, which comprises the step of identifying a type of plastic by fluorescence and/or absorption of ultraviolet, visible or near-infrared light.

3. The method according to claim 1 or 2, which comprises the step of identifying a type of plastic by fluorescence and/or absorption of visible light.

4. The method according to any one of claims 1 to 3, wherein a step of identifying and enriching plastic items by near-infrared is performed prior to the step of identifying and enrichment of plastic items based on the fluoresce or absorbance of said fluorescent and/or visible light absorbing molecules.

5. The method according to any one of claims 1 to 4, wherein the one or of different types of plastics in said composition comprises at least 50, 60, 70, 80 or 90% (w/w) of black or dark plastic.

6. The method according to any one of claims 1 to 5, wherein said molecule is a fluorescent molecule.

7. The method according to any one of claims 1 to 6, where the enrichment is performed using a fluorescent and/or visible light absorbing molecule that preferentially binds or diffuses into a specific type of plastic.

8. The method according to any one of claims 1 to 7, where the enrichment is performed using a fluorescent and/or visible light absorbing molecule that is preferentially absorbed within a specific type of plastic.

9. The method according to any one of claims 1 to 8, wherein the enrichment is performed using a fluorescent and/or visible light absorbing molecule that, depending on the type of plastic it binds to, has a different emission spectrum upon ultraviolet irradiation or a different absorption spectrum in the visible or near-infrared range.

10. The method according to any one of claims 1 to 9, wherein the fluorescent and/or visible light absorbing molecule is water-soluble or is soluble in a water/alcohol mixture.

11. The method according to any one of claims 1 to 10, wherein the labelling with fluorescent and/or visible light absorbing molecule is performed by applying 1 g to 1 kg of molecule per ton plastic items.

12. The method according to any one of claims 1 to 11, wherein the labelling with the fluorescent and/or light-absorbing molecule is performed during washing of the plastic items in the composition.

13. The method according to the previous claim wherein the washing solution comprises between 1 mg-10000 mg fluorescent and/or visible light absorbing molecule per litre solution.

14. The method according to any one of claims 1 to 13, wherein the composition is food waste comprising plastic items.

15. The method according to any one of claims 1 to 14, wherein the plastic items are shredded plastic items.

16. The method according to any one of claims 1 to 15, wherein the binding of the fluorescent and/or visible light absorbing molecule to the plastic item is non-covalent.

17. The method according to any one of claims 1 to 16, wherein the fluorescent and/or visible light absorbing molecule is removed by washing the plastic items with a solution comprising at least 1, 10, 25, 50 or 75% of an alcohol.

18. The method according to any one of claims 1 to 17, wherein the dye is food grade.

19. The method according to any one of claims 1 to 18, wherein a fluorescent and/or light-absorbing molecule is used which preferentially binds to or diffuses into the plastic type which is least abundant in the mixture.
